(19) United States
(12) Patent Application Publication
(10) Pub. No.: US 2011/0112876 A1
(43) Pub. Date: May 12, 2011

(54) Method and Tools for Progressively Scaling Maturity of Information Technology Organizations

(75) Inventors: Vijay P. Khare, Mumbai (IN); Pradeep K. Waychal, Thane west (IN); Sunil S. Chitale, Mumbai (IN); Vijay V. Kaulgud, Mumbai (IN)

(73) Assignee: PATNI COMPUTER SYSTEMS LTD., Mumbai (IN)

(21) Appl. No.: 12/917,876

(22) Filed: Nov. 2, 2010

Related U.S. Application Data
(60) Provisional application No. 61/258,719, filed on Nov. 6, 2009.

(51) Int. Cl. G06Q 10/00

(52) U.S. Cl. 705/7.11

(57) ABSTRACT

A method of assessing and improving capability of information systems (IS) management in an organization using a computer system is provided. The method gathers responses related to strategic aspects of the IS management from a plurality of stakeholders in the organization, determines incongruence between the responses using the computer system, determines a change management efficiency for each of the strategic aspects based on the responses using the computer system, and provides an assessment of the capability based on the responses, the incongruence, and the change management efficiency.

### CROSS REFERENCE TO RELATED APPLICATIONS

The present application claims priority to U.S. Provisional Patent Application No. 61/258,719 filed Nov. 6, 2009, the disclosure of which is incorporated by reference herein in its entirety.

### TECHNICAL FIELD

The present invention generally relates to assessing the capabilities of information systems (IS) management and, more particularly, the invention relates to assessing and improving the capabilities of IS management in an organization.

### BACKGROUND ART

Currently, there are different models that seek to provide a framework for improving business processes in an organization. For example, in the field of software development, the Capability Maturity Model (CMM) was developed to provide a tool for assessing the software development business processes in an organization. Other models include PCMM, ITIL and CoBIT, just to name a few. These process improvement approaches describe the current maturity levels of existing processes in the areas of interest and use that information to implement process performance improvements. These approaches, however, typically focus efforts for improving performance on limited aspects of the business management and usually analyze business management in isolation without considering its internal and external relationships with customers and vendors.

### SUMMARY OF EMBODIMENTS

In accordance with one embodiment of the invention, a method of assessing capability of information systems (IS) group in an organization using a computer system is provided. The method gathers responses related to strategic aspects of the IS management from a plurality of stakeholders in the organization, determines incongruence between the responses using the computer system, determines a change management efficiency for each of the strategic aspects based on the responses using the computer system, and provides an assessment of the capability based on the responses, the incongruence, and the change management efficiency.

In some embodiments, the method of claim may further include generating a plan for improving the capability based on the assessment. The assessment may be based on the responses, the determined incongruence, and the determined change management efficiency for one of the stakeholders, and the plan may be based on the assessment for the one stakeholder. The plurality of stakeholders may include at least one person from strategic leadership, middle management, and engineering members in each corresponding IS organization, business organization, and supplier organization. The strategic aspects may include process and technology assets, building IS organization, value innovation, governance risk and compliance, and business relationship management. The method may further include storing the responses in the computer system. Each of the responses may be assigned a value. The process of determining incongruence between responses may include calculating a difference in the values assigned to at least one response from at least two different stakeholders for a given aspect. The process of providing an assessment of the capability may include assigning a maturity level to each of the strategic aspects.

In accordance with another embodiment of the invention, a system of assessing capability of information systems (IS) management in an organization includes memory for storing responses related to strategic aspects of the IS management from a plurality of stakeholders in the organization. Each of the responses may be assigned a value. The method of assessing the strategic aspects may include assigning and aggregating maturity levels of individual actions that are part of each of the strategic aspects. The system also includes a first determining module coupled to the memory and configured to determine incongruence between the responses stored in the memory. The system of determining incongruence between responses from at least two different stakeholders for a given aspect may include calculating an average of absolute deviations of values assigned to the responses from their mean value. The system also includes a second determining module coupled to the memory and configured to determine a change management efficiency for each of the strategic aspects based on the responses stored in the memory, and an assessment module coupled to the memory, the first determining module and the second determining module. The assessment module is configured to provide an assessment of the capability based on the responses, the incongruence, and the change management efficiency. The system may also include a third determining module that generates at least one report suitable for different stakeholders. The report(s) may include maturity level of IS management benchmarked (e.g., comparing both internal and external benchmarks) and examples, and different possible roadmaps for improving maturity level of IS (partially or completely).

Illustrative embodiments of the invention may be implemented as a computer program product having a computer usable medium with computer readable program code thereon. The computer readable code may be read and utilized by a computer system in accordance with conventional processes.

### BRIEF DESCRIPTION OF THE DRAWINGS

The foregoing features of the invention will be more readily understood by reference to the following detailed description, taken with reference to the accompanying drawings, in which:

FIG. 1 schematically shows components of a capability assessing system according to embodiments of the present invention;

FIG. 2 shows a process of assessing capability in an organization's IS management according to embodiments of the present invention;

FIG. 3 shows an exemplary questionnaire used to gather responses from stakeholders according to embodiments of the present invention;

FIG. 4 schematically shows an IS Management Maturity Model according to embodiments of the present invention;

FIG. 5 schematically shows different maturity levels for the strategic aspects of IS management according to embodiments of the present invention;

FIG. 6 is a schematic diagram showing inputs and outputs of the capability assessing system according to embodiments of the present invention;

FIG. 7 is a schematic diagram showing additional inputs of the capability assessing system according to embodiments of the present invention;

FIG. 8 is an exemplary report generated by the capability assessing system according to embodiments of the present invention;

FIG. 9 is an exemplary report generated by the capability assessing system according to embodiments of the present invention;

FIG. 10 shows an exemplary flowchart for the “Create New Discovery” menu according to embodiments of the present invention;

FIG. 11 shows an exemplary flowchart for the “Configuring Discovery” menu according to embodiments of the present invention;

FIG. 12 shows an exemplary flowchart for the “Conduct Discovery” menu according to embodiments of the present invention; and

FIG. 13 shows an exemplary flowchart for the “Create Reports” menu according to embodiments of the present invention.

### DESCRIPTION OF ILLUSTRATIVE EMBODIMENTS

Various embodiments of the present invention provide a system and method for assessing the capability and performance of all strategic aspects of IS management and providing IS leadership with a roadmap for IS enabled business transformation. Information systems need to be efficient in operation and effective in meeting the needs of various business units in an organization. Embodiments of the present invention have identified five strategic aspects of IS management and have identified nine categories of respondents whose views are important in determining the existing capabilities of IS management. The respondents include a broad spectrum of stakeholders in the organization, including internal customers and vendors. The stakeholders include at least one person from strategic leadership, middle management, and operational or engineering members in the IS department or IS organization itself, in the business or organization as a whole, and in one or more suppliers or vendors to the organization. Responses are elicited from these stakeholders about IS performance and capability maturity related to the strategic aspects based on the stakeholders' experiences and interactions. Based on these responses, an assessment of IS management capability is provided for the five strategic aspects. A capability maturity model provides a framework to show the maturity level of IS management capability at each of these strategic aspects. The capability maturity model also allows IS leadership to evaluate the current capabilities of IS management and to build a plan for improving its capability and performance in selected areas. Thus, embodiments enable IS leadership to serve the organization's business purpose and to enable business process transformation which delivers business value to the organization. Details of illustrative embodiments are discussed below.

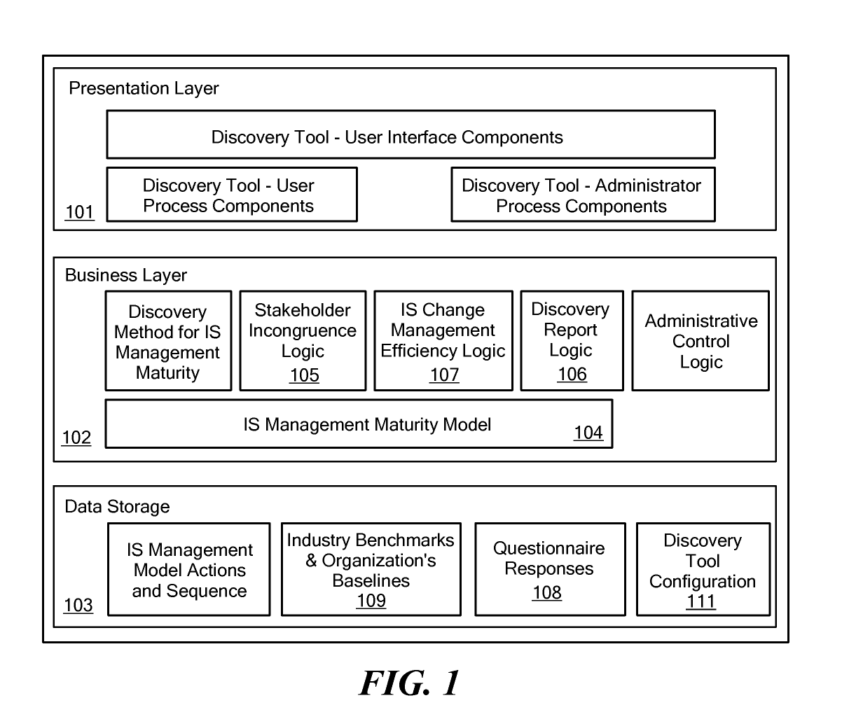

A capability assessment system 100 may be used to enter certain information, process it and derive different reports. The capability assessment system 100 includes a computer system having a user interface 101, such as shown in FIG. 1. The user interface 101 may be used to access the functionalities of the system 100, e.g., entering information related to the strategic aspects of IS management, administering surveys and entering responses from a plurality of stakeholders in the organization, configuring different aspects of the system 100, and requesting the system to generate reports. The user interface 101 may include various menus, such as a “Conduct Discovery” menu, a “Create New Discovery” menu, a “Configure Discovery” menu, and a “Create Reports” menu. The capability assessment system 100 may be configured to a specific client organization and its needs. The computer system also has one or more modules 102 that implement various processes and logic. For example, the modules 102 may include a first determining module 105 configured to determine stakeholder incongruence, a second determining module 107 configured to determine a change management efficiency, an assessment module configured to provide an assessment of the IS management capability, and modules configured to generate an IS management maturity model 104 and to generate various reports 106, as will be discussed in more detail below. The computer system also includes memory 103 for storing the responses from the stakeholders 108, information related to industry benchmarks and organizational baselines 109, and information related to the system's configuration 111.

Among other implementations, the first determining module 105, the second determining module 107, and the assessment module may be a single integrated unit having the discussed functionality, and/or a plurality of interconnected, separate functional devices. Reference to a “module” therefore is for convenience and not intended to limit its implementation. Moreover, the various functionalities within the first determining module 105, the second determining module 107, and/or the assessment module may be implemented in any number of ways, such as by means of one or more application specific integrated circuits or digital signal processors, or the discussed functionality may be implemented in software.

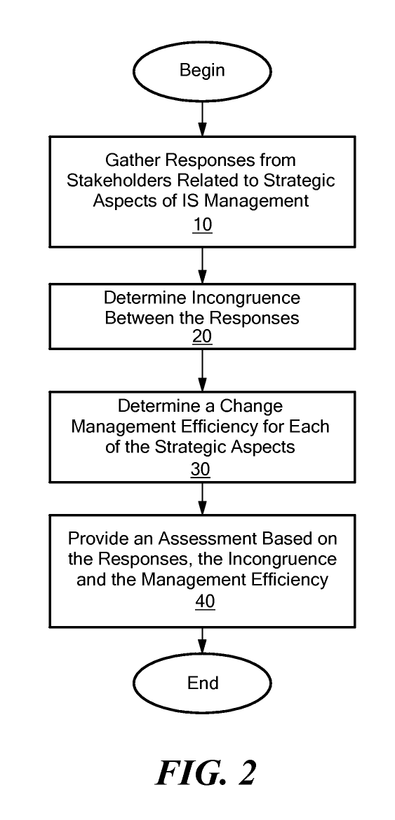

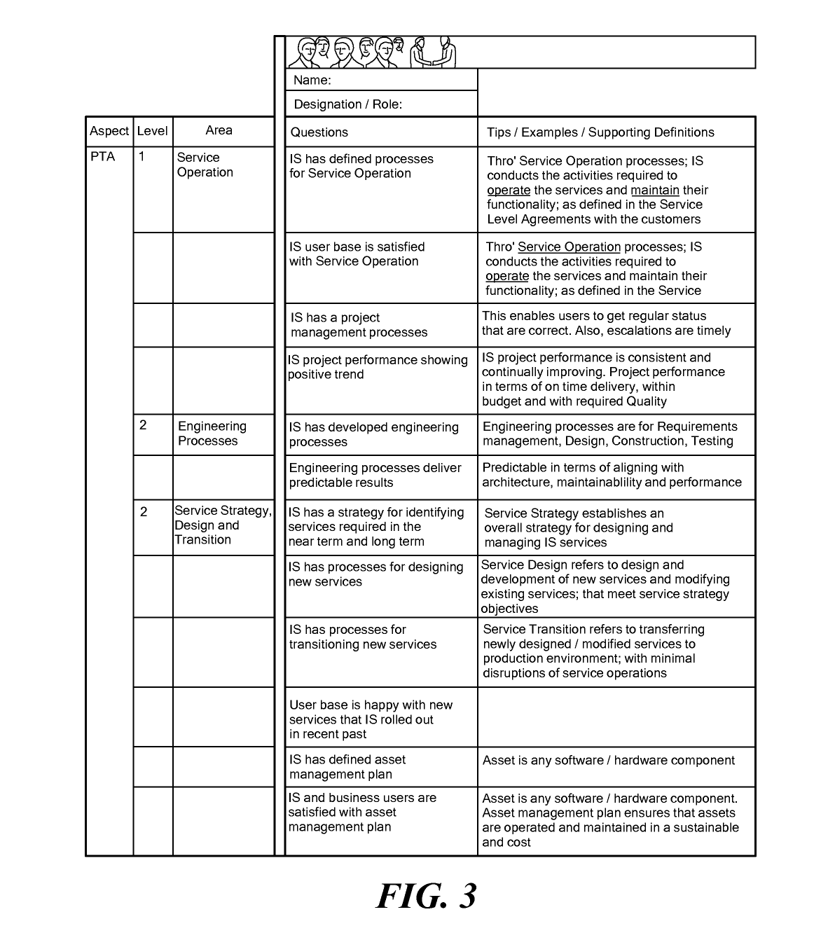

FIG. 2 shows a method of assessing capability of IS management in an organization that may be implemented using the capability assessment system 100 according to embodiments of the present invention. The process begins at step 10, which gathers responses from stakeholders related to strategic aspects of IS management. Preferably, five strategic aspects of IS management have been identified in order to cover all or substantially all activities happening in a CIO's organization, although other numbers of strategic aspects may also be used. Each strategic aspect is important to deliver and sustain intended value to the business units within the organization. As mentioned above, the responses may be entered and stored in the memory 103. FIG. 3 shows an exemplary questionnaire used to gather responses from stakeholders for one strategic aspect.

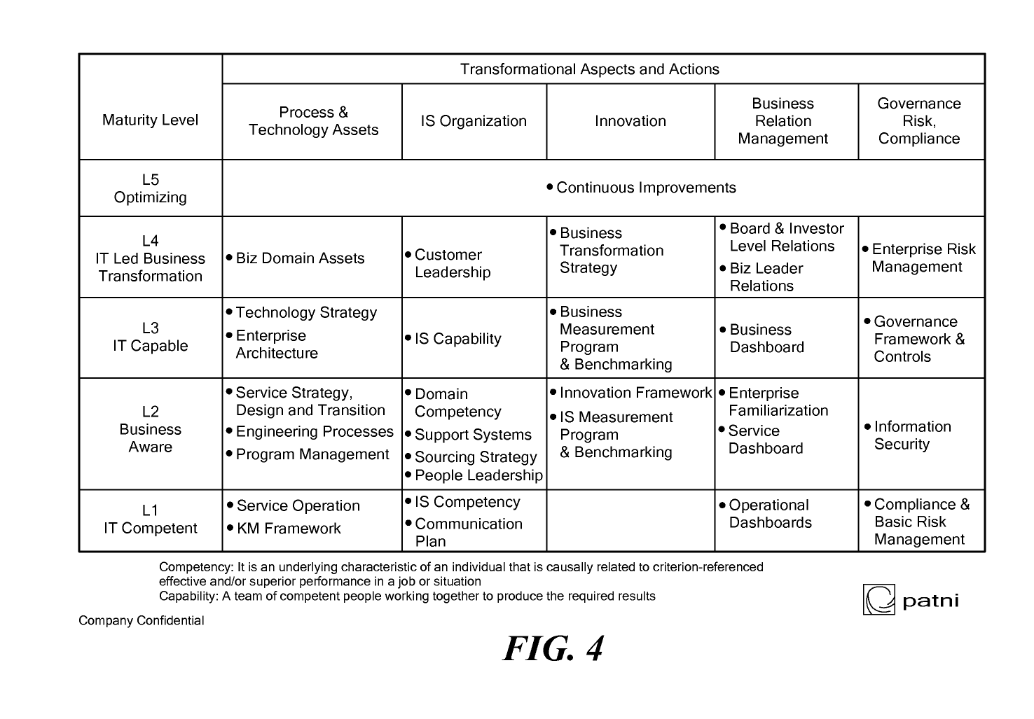

FIG. 4 schematically shows an exemplary IS Management Maturity Model with the five strategic aspects that may be generated by the capability assessment system 100. As shown, embodiments of the strategic aspects of IS Management may include Process and Technology Assets (P&TA), Building IS Organization (BIO), Value Innovation (VI), Business Relationship Management (BRM), and Governance Risk & Compliance (GRC).

P&TA focuses on important facets of IS organization, processes and technologies at the ideal state of IS Management. IS institutionalizes IS processes and IS technologies to ensure predictability and consistency across all IS capabilities and suppliers. IS service strategy sets the direction of IS service lifecycle, based on which IS designs, develops and institutionalizes business technology assets to meet the needs of the customers. Adoption of proven industry best practices, such as ITIL and other frameworks like CMMI, ensure using the already tried and tested practices.

BIO actions ensure that the IS organization has the right structure and competencies to be effective and efficient in its operations. BIO actions create IS leaders who command respect from their business counterparts, which are the customers of an IS organization. BIO actions further ensure that the IS team has the required basic technical, managerial and people competencies to deliver technical solutions. BIO actions build mechanisms for the IS team to collaborate within team, with IS leadership and with IS stakeholders. BIO requires IS leadership to develop awareness within the IS organization about the expectations from business and the organization's strategy. BIO covers the people aspect of the IS Organization.

Embodiments of the present invention acknowledge the importance of building strong relations with the business counterparts in order to capture and deliver the right value. BRM requires the IS team to understand the business expectations. BRM enables understanding of pressing needs that are critical to senior management, including the board, and meeting them. BRM facilitates prioritizing IS initiatives within given constraints to maximize customer benefits. BRM necessitates the IS organization to fulfill the information needs of the leadership and stakeholders regarding the performance and value of IS Assets.

Embodiments of the present invention acknowledge the importance of “Value Innovation” in order to deliver intended value of IS to the stakeholders and to enable business transformation. VI actions apply the sound understanding of IS capabilities, insights from benchmarking of IS and business processes, business priorities, competitive drivers and different trends in IS domain to come up with different ideas for incremental and radical innovation. VI actions build channels to elicit innovative ideas, deploy mechanisms to evaluate and realize the potential of these ideas. Ideas that align with IS and business priorities and that make a strong business case are realized. VI enables adding value initially in the IS sphere and later in the business sphere at higher maturity level.

Embodiments of the present invention acknowledge the importance of “Governance, Risk and Compliance” in order to ensure compliance to all applicable regulations in order to minimize service fluctuations and to ensure service continuity and business stability. IS governance as part of the GRC actions provides the structure and framework to ensure adequate visibility, right decisions by the right person and timely escalation. These actions make available the real-time knowledge of performance of all IS capabilities, projects and vendors, including costs, tangible and intangible value delivered. The IS risk management part of the GRC actions helps identify various types of risks, develop a forewarning system, and provide actionable and cost effective recommendations on contingency and mitigation actions. Improved management visibility into current risks enables faster and informed business-critical decisions. The IS compliance part of the GRC actions scan the environment to check regulation applicability and provide the flexibility to adjust to new or updated regulatory requirements. IS compliance actions strive to reduce the cost of compliance. GRC actions ensure clear, timely communication of risks and compliance status to business users and decision makers.

The IS Management Maturity Model also defines different maturity levels for the strategic aspects of IS management. The IS Management Maturity Model may include descriptors corresponding to each maturity level. A maturity level is defined as an evolutionary plateau of process and business performance improvement. Each maturity level of IS management aims at stabilizing an important part of the IS organization's capabilities.

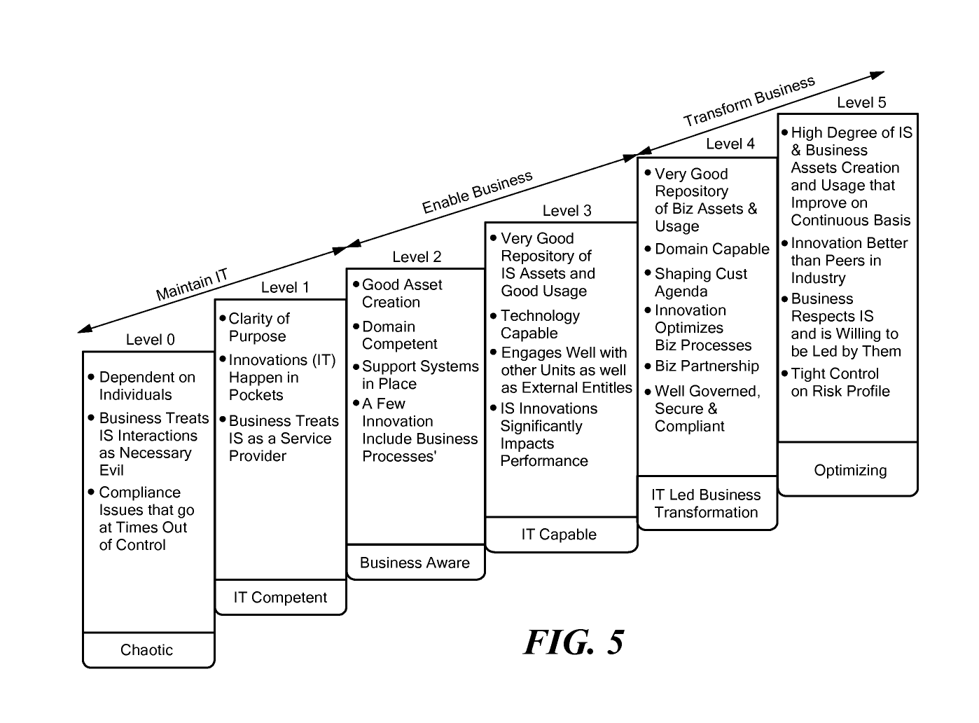

Referring also to FIG. 5, the maturity levels include Level 0-Chaos, Level 1-IT Competent, Level 2-Business aware, Level 3-IT Capable, Level 4-IT led business transformation and Level 5-Optimizing. The well-defined maturity levels serve as the basis for assessing the maturity level of capabilities of IS management. The IS Management Maturity Model may also qualify each maturity level with a predefined set of IS management actions, pre-requisites, dependencies and clear descriptors. A particular maturity level is achieved for each of the strategic aspects when IS management is able to efficiently, effectively and consistently complete the IS management actions identified.

For example, at IS Management Maturity Level 0, IS processes are usually ad hoc and chaotic. IS organization usually does not provide a stable environment. Success in the organization typically depends on the competence and heroics of the people in the organization and not on the use of proven processes. Frequent regulatory non-compliance may be expected at this level.

At IS Management Maturity Level 1, the IS organization has implemented all the IS management actions defined for maturity level 1. Services are provided to the business clients as specified. The IS organization often produces products and services that work; however, they frequently exceed the budget and schedule of their projects. The IS team has the required technical competencies, but needs to be spoon fed with requirements and expectations. Implicit requirements are not well understood and hence the impression carried by business clients is not very good. Business expects that the basic IT infrastructure will be maintained well. However, enhancements may bring in uncertainty in continuing the business processes without interruptions. While there may not be any regulatory non-compliance, occasional security breaches may be expected. At this level, business looks at IS with skepticism.

At IS Management Maturity level 2, the IS organization has implemented all required actions to provide maturity level 1 and 2 services to the business. At maturity level 2, the IS team has extended its competency to business domain. IS leadership now understands the business basics and the aspects on which their enterprise competes in the market. The basic intent of maturity level 2 is to understand the business logic and domain. Implied needs are understood and priorities for IS capabilities are set. IS aligns all their resources with the business requirements to ensure better results. The IS leadership team has a service strategy to cater to business needs. An important distinction between maturity level 1 and maturity level 2 is the domain expertise and attempt made to understand business priorities at maturity level 2. Proactive steps are taken by IS leadership and his/her team to build relations with their business counterparts. Another important distinction at maturity level 2 is the zest to improve IS operations, measuring performance and sharing it with business counterparts to receive feedback. IS starts nurturing innovation. There may not be any security lapses, but there may be surprises due to lack of clarity and governance framework. At this level, IS is accepted by business users.

At IS Management Maturity level 3, the IS Organization has implemented all actions to provide services identified in maturity levels 1, 2, and 3. At Level 3, IS team members build their capability such that they are able to deliver to the expectations of business clients. They have best in class IS processes which are scalable to meet the changing business needs. Though IS has its organization in order, it is not yet measuring business process performance with a view to identify improvement opportunities. At this level, IS is respected by business users.

At IS Management Maturity Level 4, the IS organization has implemented all actions to provide services in maturity levels 1, 2, 3, and 4. At this stage, the IS team penetrates in business processes, evaluates them and suggests radical improvements which could change the way these processes were executed. Maturity level 4 focuses on IS delivering to, or driving, the enterprise strategy of differentiation. Business domain assets prove to be one of the strongest sources of competitive differentiation and customer delight for the business. An important distinction between maturity level 3 and maturity level 4 is the customer leadership attained at maturity level 4. At maturity level 3, IS is responsive and offers the best flexibility to meet business needs. However, at maturity level 4, IS suggests the end state. IS influences business to adopt the best in class processes driven by technology. At this level, business trusts IS.

At IS Management Maturity Level 5, the IS organization has implemented all actions to deliver services as required by levels 1, 2, 3, 4, and 5. Maturity level 5 focuses on maintaining the leadership position in leading the transformation initiative. It ensures that IS is not slipping back or is not being complacent. Quantitative process-improvement objectives for the organization are established, continually revised to reflect changing business objectives, and used as criteria in managing process improvement. The effects of the deployed process improvements are measured and evaluated against the quantitative process-improvement objectives. Both the defined processes and the organization's set of standard processes are targets of measurable improvement activities. An important distinction between maturity level 4 and maturity level 5 is that of achieving and maintaining the state, as in the case of maturity level 5. At maturity level 5, specific initiatives are identified to ensure sustenance. Actions at this maturity level act against the elastic force of going back to the old ways. At this level, business respects IS.

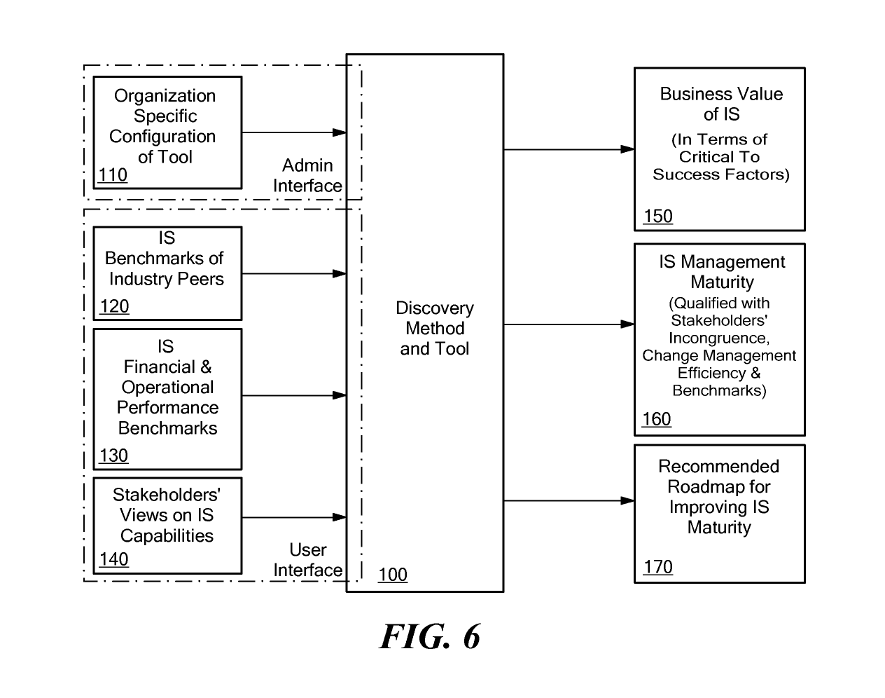

FIG. 6 is a schematic diagram showing some inputs and outputs of the capability assessing system 100. As shown, the responses of stakeholders 140 is one input to the capability assessment system 100. Other inputs may also include various benchmarks, e.g., IS benchmarks of industry peers 120 and IS financial & operational performance benchmarks 130, and organization specific information or configuration of the system 110.

Returning to the process of FIG. 2, once responses are gather from at least one person from each of the categories of respondents, (e.g., preferably nine categories) incongruence between the responses is determined for each of the strategic aspects in step 20. The incongruence between responses may be determined by assigning a value to each of the responses and then calculating an average of the absolute deviations of values assigned to the responses from their mean value. If two or more responses from one stakeholder type are gathered for a given aspect, then incongruence is also calculated within the stakeholder type. As mentioned above, the incongruence may be determined by the first determining module 105 using the responses, and the responses may be stored in the memory 103.

In step 30, a change management efficiency for each of the strategic aspects is determined. The change management efficiency is the ability to translate defined IS management actions, as laid out in the IS Management Maturity Model, into precise improvement of specific IS management actions. In other words, it is the ability to implement the defined process to achieve expected results. As mentioned above, the change management efficiency may be determined by the second determining module 107 using the responses and comparing them to ideal goals of the model.

In step 40, an assessment of the capability of IS management is provided based on the responses, the incongruence and the change management efficiency. As mentioned above, the assessment may be determined by the assessment module 107. As shown in FIG. 6, the capability assessment system 100 may provide the assessment and other various reports as an output from the system 100, such as the IS Management Maturity assessment 160. Other outputs, such as a computed business value of IS 150 to the organization and a recommended roadmap for improving IS maturity 170 may also be generated.

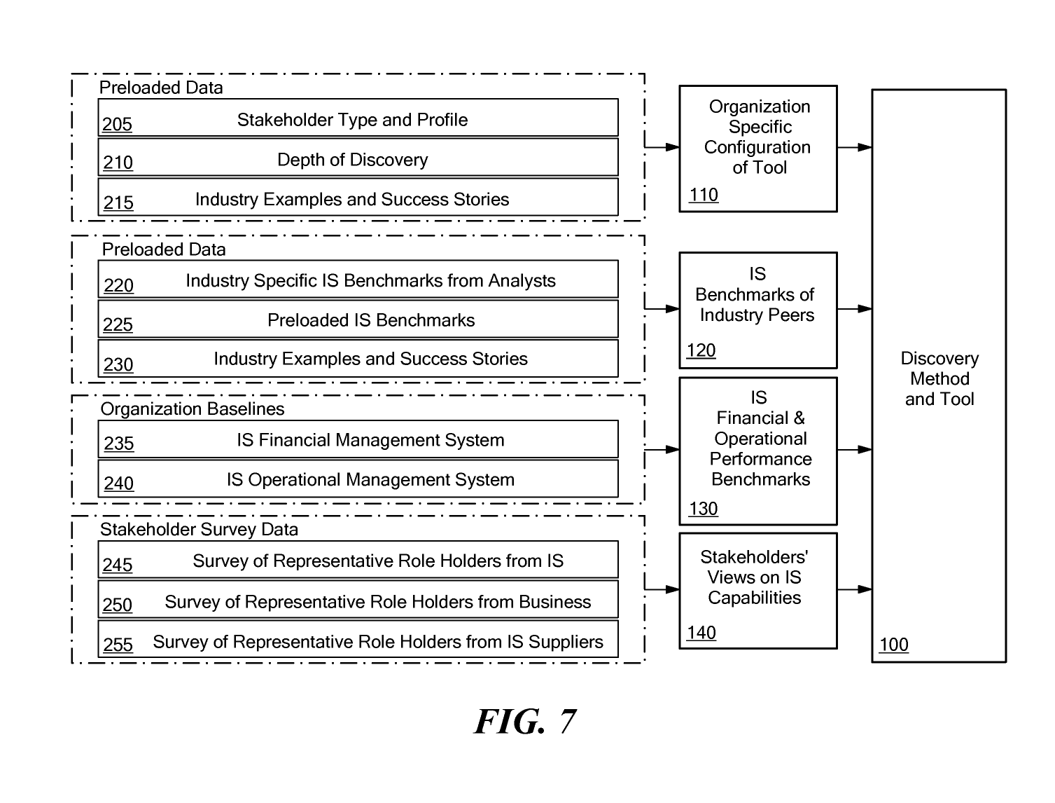

FIG. 7 is a schematic diagram showing additional inputs of the capability assessing system 100 that may be used. For example, the system configuration 110 may include stakeholder type and profile information 205, the depth of the responses from stakeholders 210, and industry examples 215. The IS benchmarks of industry peers 120, may include industry specific IS benchmarks from analysts 220 (e.g., an analyst from Patni), preloaded IS benchmarks 225, and industry examples and success stories 230. The IS financial and operational performance benchmarks 130, may include organizational baselines, such as IS financial management system 235 and IS operational management system 240. The stakeholders views on the IS capability 140 may include stakeholder survey data, such as a survey of representative role holders from IS 245, a survey of representative role holders from business 250, and a survey of representative role holders from IS suppliers 255.

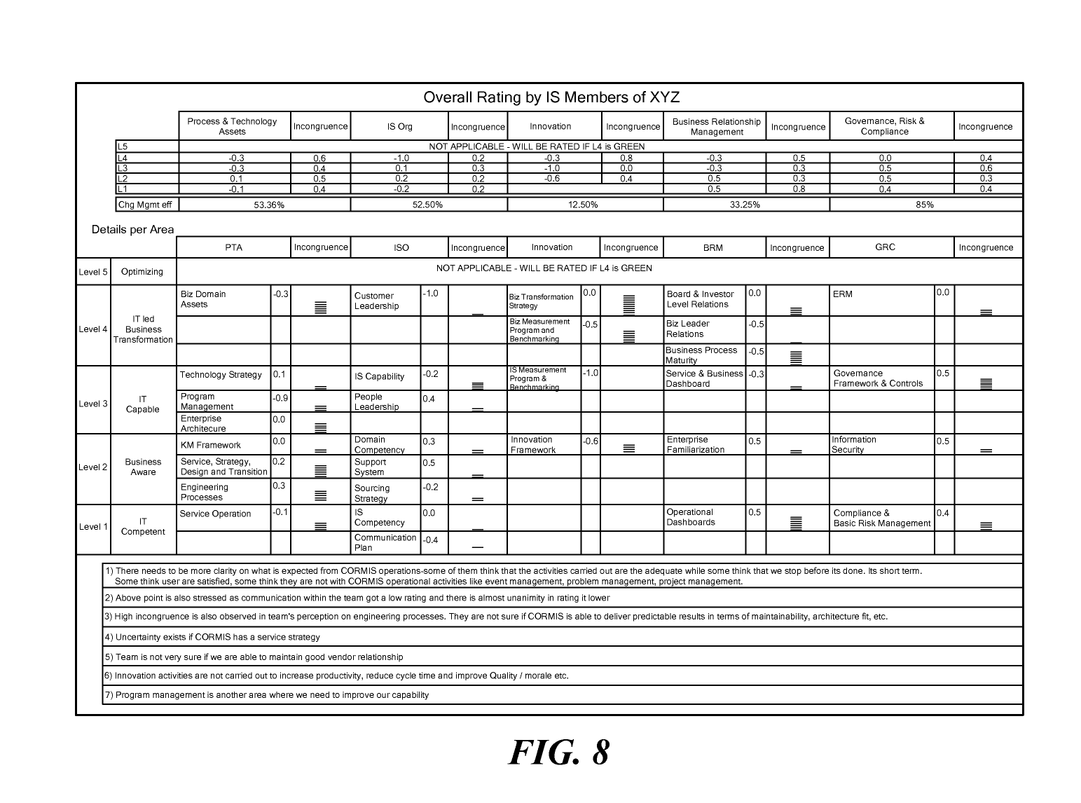

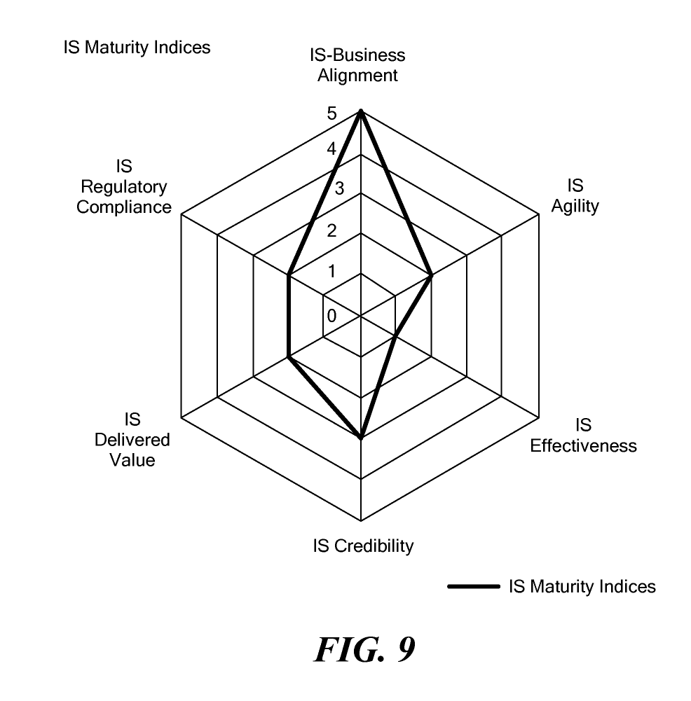

FIGS. 8 and 9 show examples of reports that may be generated by the system 100. A variety of reports may be generated for different stakeholders. For example, reports may include a maturity level of IS with benchmarking (comparing both internal and external benchmarks), different possible roadmaps for improving maturity level of IS (partially or completely), prerequisites and dependencies, efficiency of existing IS to deliver the intended functionality. The roadmaps may include different approaches to improve maturity level of IS management, such as a fast track approach, a staged approach for improving the maturity level of all IS management aspects, or a focused approach for improving the maturity level of specific IS management aspects or specific IS management actions. For example, FIG. 8 is a report showing the assessed maturity level, along with the incongruence and the change management efficiency, for each of the five strategic aspects shown in the IS Management Maturity Model of FIG. 4. The report may display whether the levels have been achieved for the various aspects by color coding the results. For example, each level under each aspect may show green if all requirements are met, yellow if the requirements are only partially met, and red if the requirements are not met. FIG. 9 is a report showing one user view for current maturity indices of IS for a chosen set of goals.

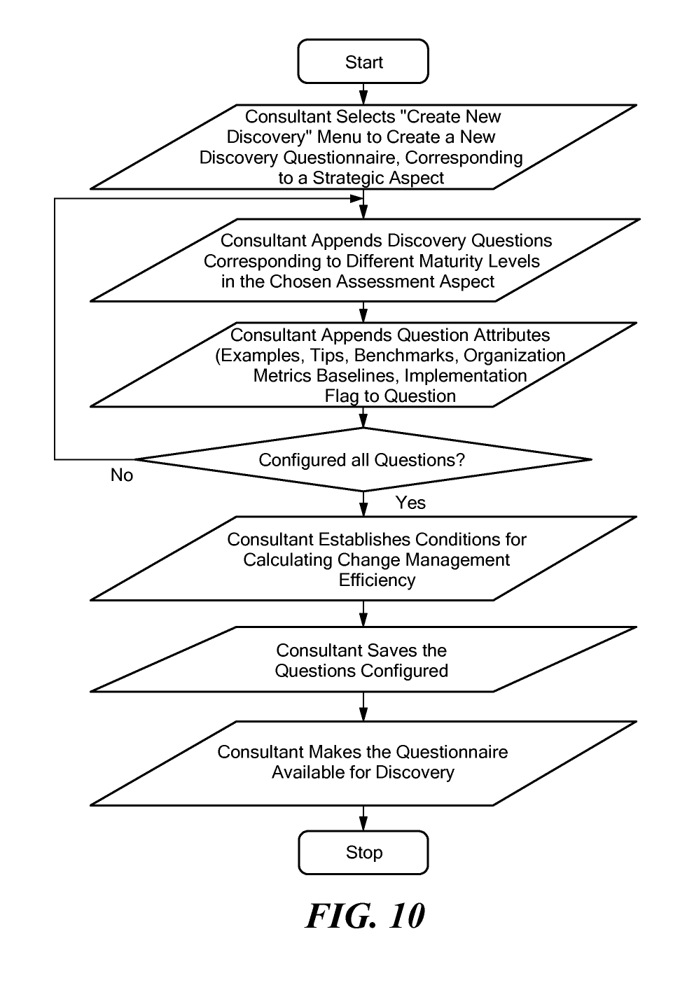

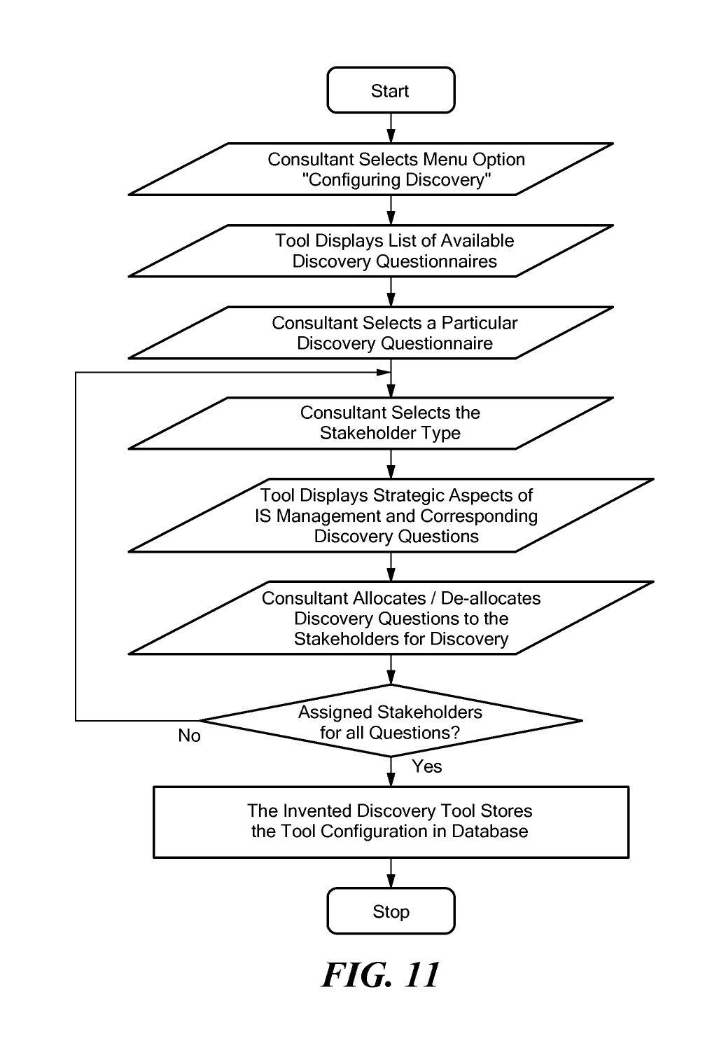

FIG. 10 shows an exemplary flowchart for the “Create New Discovery” menu option. FIG. 11 shows an exemplary flowchart for the “Configuring Discovery” menu option. For example, the user interface 101 may display a list of available discovery questionnaires and IS management aspects. A “new-discovery” questionnaire and a particular IS management aspect may be selected. The discovery type may be chosen as a part of the system's configuration. The user interface 101 may display preconfigured questions for the chosen stakeholder. The activation or deactivation of individual questions for each stakeholder type may be modified. The system configuration stored in the database 103 may be saved.

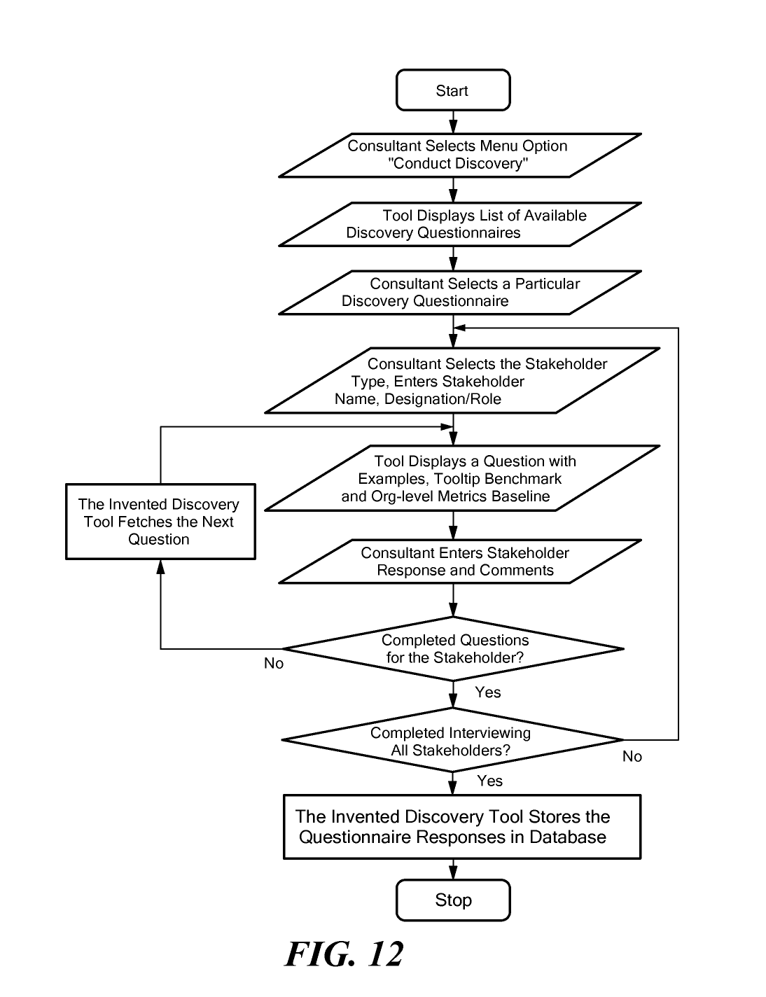

FIG. 12 shows an exemplary flowchart for the “Conduct Discovery” menu option. As shown, the menu option “Conduct Discovery” may be selected. The user interface 101 may display a list of available discovery questionnaires and IS management aspects. A particular discovery questionnaire and a particular IS management aspect, e.g., master questionnaire/business relationship management may be selected. The interviewee information, such as stakeholder type, may be selected and other information, e.g., stakeholder name (optional) and designation/role, may be entered. The system 100 may display a discovery screen specific to the stakeholder type where relevant question, tips and examples, and benchmarks may be displayed. The stakeholder responses may be entered on the discovery screen. The responses from stakeholders may be saved in the system's memory 103. The process may be repeated till responses from all the stakeholders are gathered. The system may include a provision for automated selection or de-selection of questions based on the actual dynamics of the discovery. The system may provide a feature to add some new assessment questions while conducting discovery. The system may be configured with relevant question attributes such as organization baselines, industry benchmark, implementation flag, aspect and maturity level.

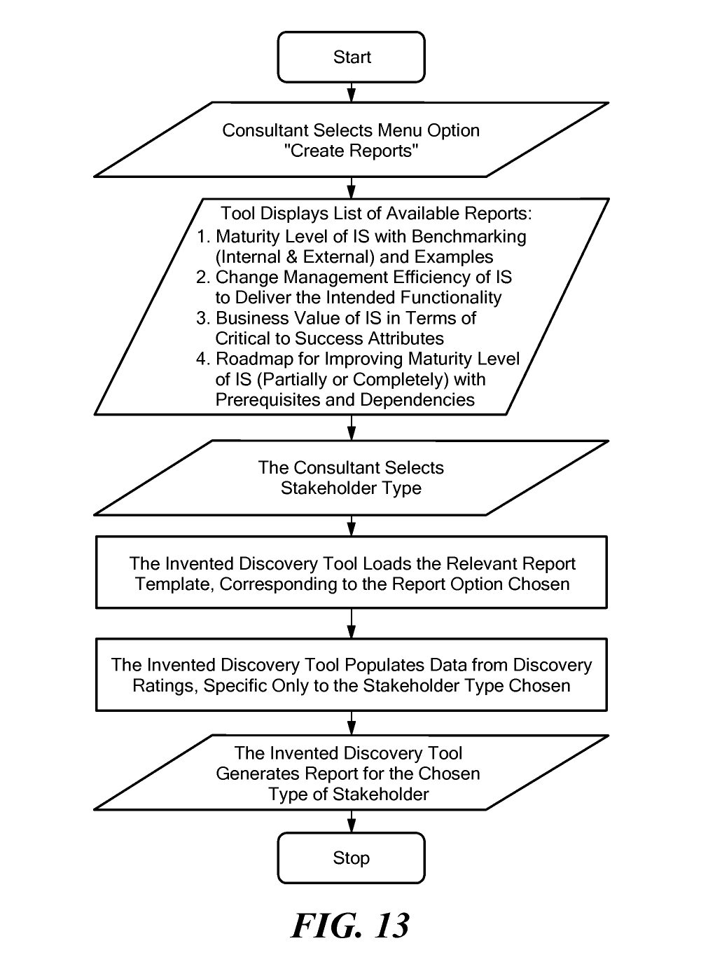

FIG. 13 shows an exemplary flowchart for the “Create Reports” menu option. As shown, the menu option “Create Report” menu may be selected. A “Report Type” may be selected from the following options:
1. Maturity level of IS with benchmarking (internal & external) and examples;
2. Different possible roadmaps for improving maturity level of IS (partially or completely) with prerequisites and dependencies;
3. Efficiency of existing IS to deliver the intended functionality; and
4. Business value of IS in terms of critical to success attributes.

The stakeholder type for which the report is being generated may be selected. The system may load the relevant report template corresponding to the report option chosen. The system may populate data from discovery ratings, specific only to the stakeholder type chosen. The system may generate one or more reports for the chosen type of stakeholder.

Embodiments of the present invention provide comprehensive coverage of the entire gamut of IS endeavors and recognizes the importance of the entire gamut of IS endeavors which, when orchestrated as per the IS management actions, delivers the expected business value. This approach is broader in scope and includes processes and technologies, people and organization, value innovation, governance risk and compliance, and business relationship management, and is unlike the existing available Maturity Models, which focuses efforts for improving IS performance on fewer aspects of IS management in isolation.

Embodiments of the present invention also provide a well-structured roadmap for improving IS management maturity. It is beneficial to define the interrelationships, pre-requisites, dependencies and right sequence for IS management actions in order to improve the maturity of IS management. This ensures that the facilitators are leveraged and inhibitors are taken care of before investing any efforts for advancing up in the maturity level and improving performance of IS.

Embodiments of the present invention also help to accurately identify problem areas, by providing an accurate picture of the maturity of IS management. This is because the insights and responses are based on the views and experiences of strategic leadership, middle management and engineering stakeholders across IS, business and supplier organizations. Also, the participation from the stakeholders helps in accurately identifying the effectiveness of IS management using the incongruence amongst different stakeholders. The system also reveals the change management efficiency of IS management actions, i.e., the ability to translate defined IS management actions into precise implementation of specific IS management actions. This accurate identification of the problem areas helps the IS leadership to undertake the right sequence of improvement actions for IS management and eliminate the incongruence amongst the stakeholders.

Embodiments of the present invention also help to deliver the business value by IS, in terms of critical to success factors for business in areas such as IS-business alignment, IS agility, IS effectiveness, IS credibility, IS delivered value and IS regulatory compliance. The present system and method allow leadership to focus the scarce resources selectively on high impact areas to deliver business value.

Embodiments may be implemented as a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions may embody all or part of the functionality previously described herein with respect to the method and system. Those skilled in the art should appreciate that such computer instructions may be written in a number of programming languages for use with many computer architectures or operating systems. For example, embodiments may be implemented in a procedural programming language (e.g., “C”) or an object oriented programming language (e.g., “C++”). Alternative embodiments of the invention may be implemented as pre-programmed hardware elements, other related components, or as a combination of hardware and software components.

Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Thus, some embodiments of the invention may be implemented as hardware, software (e.g., a computer program product), or a combination of both software and hardware.

Although the above discussion discloses various exemplary embodiments of the invention, it should be apparent that those skilled in the art can make various modifications that will achieve some of the advantages of the invention without departing from the true scope of the invention.

What is claimed is:

1. A method of assessing capability of information systems (IS) management in an organization using a computer system and an IS Management Maturity Model, the method comprising:
gathering responses related to strategic aspects of the IS management from a plurality of stakeholders in the organization;
determining incongruence between the responses from the plurality of stakeholders using the computer system;
determining a change management efficiency for each of the strategic aspects based on the responses using the computer system; and
providing an assessment of the capability based on the responses, the incongruence, and the change management efficiency.

2. The method of claim 1, further comprising:
generating a plan for improving the capability based on the assessment.

3. The method of claim 2, wherein the assessment is based on the responses, the determined incongruence, and the determined change management efficiency for one of the stakeholders, and the plan is based on the assessment for the one stakeholder.

4. The method of claim 1, wherein the assessment is based on the responses, the determined incongruence, and the determined change management efficiency for one of the stakeholders.

5. The method of claim 1, wherein the plurality of stakeholders includes at least one person from strategic leadership, middle management, and engineering members in each corresponding IS, business, and supplier organizations.

6. The method of claim 1, wherein the strategic aspects include process and technology assets, building IS organization, value innovation, governance risk and compliance, and business relationship management.

7. The method of claim 1, further comprising:
storing the responses in the computer system, wherein each of the responses is assigned a value.

8. The method of claim 7, wherein determining incongruence between responses includes calculating an average of absolute deviations of the values assigned to the responses of the stakeholders from their mean value from at least two different stakeholders for a given strategic aspect.

9. The method of claim 1, wherein providing an assessment of the capability includes assigning a maturity level to each of the strategic aspects.

10. A computer program product, for use on a computer system, for assessing capability of information systems (IS) management in an organization, the computer program product comprising a computer usable medium having computer readable program code thereon, the computer readable program code comprising:
program code for gathering responses related to strategic aspects of the IS management from a plurality of stakeholders in the organization;
program code for determining incongruence between the responses from the plurality of stakeholders;
program code for determining a change management efficiency for each of the strategic aspects based on the responses; and
program code for providing an assessment of the capability based on the responses, the incongruence, and the change management efficiency.

11. The computer program product of claim 10, wherein the computer readable program code further comprises:
program code for generating a plan for improving the capability based on the assessment.

12. The computer program product of claim 11, wherein the assessment is based on the responses, the determined incongruence, and the determined change management efficiency for one of the stakeholders, and the plan is based on the assessment for the one stakeholder.

13. The computer program product of claim 10, wherein the computer readable program code further comprises:
program code for generating at least one report using templates, the assessment and an IS Management Maturity Model.

14. The computer program product of claim 10, wherein the assessment is based on the responses, the determined incongruence, and the determined change management efficiency for one of the stakeholders.

15. The computer program product of claim 10, wherein the plurality of stakeholders includes at least one person from strategic leadership, middle management, and engineering members in each corresponding IS, business, and supplier organizations.

16. The computer program product of claim 10, wherein the strategic aspects include process and technology assets, building IS organization, value innovation, governance risk and compliance, and business relationship management.

17. The computer program product of claim 10, wherein the computer readable program code further comprises:
program code for storing the responses in the computer system, wherein each of the responses is assigned a value.

18. The computer program product of claim 17, wherein determining incongruence between responses includes calculating an average of absolute deviations of the values assigned to the responses of the stakeholders from their mean value for a given strategic aspect.

19. The computer program product of claim 10, wherein the program code for providing an assessment of the capability includes program code for assigning a maturity level to each of the strategic aspects.

20. A system of assessing capability of information systems (IS) management in an organization comprising:
memory for storing responses from a plurality of stakeholders in the organization related to strategic aspects of the IS management;
a first determining module coupled to the memory and configured to determine incongruence between the responses stored in the memory;
a second determining module coupled to the memory and configured to determine a change management efficiency for each of the strategic aspects based on the responses stored in the memory; and
an assessment module coupled to the memory, the first determining module and the second determining module, the assessment module configured to provide an assessment of the capability based on the responses, the incongruence, and the change management efficiency.

21. The system of claim 20 further comprising:
a third determining module that generates at least one report, the at least one report including at least one of maturity level of IS management benchmarked, examples and one or more roadmaps for improving maturity level of IS based on an IS Management Maturity Model.
